(19) United States
(12) Patent Application Publication
(10) Pub. No.: US 2007/0074413 A1
(43) Pub. Date: Apr. 5, 2007

(54) Digital speed square apparatus and method for using the same

(76) Inventor: Brad J. Neuroth, Nampa, ID (US)

Correspondence Address: STEPHEN M. NIPPER;DYKAS, SHAVER & NIPPER, LLP, PO BOX 877, BOISE, ID, 83701-0877, US

(21) Appl. No.: 11/243,877

(22) Filed: Oct. 4, 2005

(51) Int. Cl. B43L 13/00

(52) U.S. Cl. 33/429

(57) ABSTRACT

A combination rafter angle square with integral measuring device for allowing a construction framer to quickly and easily layout wall stud locations, floor joist locations, floor truss locations and other layouts.

### BACKGROUND OF THE INVENTION

1. Field of the Invention

The present invention generally relates to construction tools, and more particularly relates to rafter angle squares further configured for measuring distances.

2. Background Information

A rafter angle square is a generally triangular piece of material (typically metal or plastic) which is used to determine and mark the correct base and common cut marks for rafters. Rafter angle squares are used for rafter layouts by construction framers, however a rafter angle square is also a “square,” meaning that it has a generally perpendicular measuring edge which is frequently used by framers to draw straight lines upon pieces of dimensional lumber thereby marking the placement of wall studs, cuts, and the like.

U.S. Pat. No. 5,170,568 to Wright notes that rafter angle squares “enable the roofing carpenter to mark and cut the base cut of a rafter. The rafter base cut is a horizontal cut at the bottom extreme of the rafter. The angle between the base cut and longitudinal axis of the rafter is a function of the slope of the roof. The rafter angle square currently enjoying the greatest usage by roofing carpenters in this country is Swanson's Marking Tool with Wear Rims (U.S. Pat. No. 4,742,619). Swanson's Marking Tool features a scale parallel to the tool hypotenuse which incorporates roof unit rise values typically ranging from one inch roof risers per foot roof run to 30 inches roof rise per foot roof run. This scale is used to mark the base cut angle of a rafters. Roofing carpenters are [also] frequently required to make rafter common cut marks while perched atop of the roof under construction.”

Cottongim, et al., (U.S. Pat. No. 5,575,074) further reminds us that “roof framers and many other trades typically make daily use of triangular shaped framing squares known as speed squares,” and that the “primary reason for the popularity of speed squares is that they are small and lightweight making them suitable for replacing bulky framing squares and T-squares. A very common use for speed squares is to square scribe building materials such as lumber, roofing, and the like.”

One such “square scribe” use of such a rafter angle square is in the layout of a building's wall. In such an instance, a framer will lay out a piece of dimensional lumber which would serve as the base plate for the wall. The framer then uses a tape measure and a writing utensil (pen, pencil) to mark the appropriate stud locations for the wall. For instance, placing regular marks on the piece of dimensional lumber representing a sixteen (16) inch “on center” stud arrangement. After marking all of the “on center” locations, the framer will then come back to the marks and use a square to draw straight lines.

What is needed is a novel combination of a rafter angle square and a tape measure for simplifying the framer's job in laying out walls and other components within the building. Obviously, by combining the measuring ability of the tape measure into the straight edge of the rafter angle square, much time and effort could be conserved. Further, by marking the line the first time (instead of coming back later to create the formal mark) accuracy is increased.

### SUMMARY OF THE INVENTION

One embodiment of the present invention is a measuring rafter angle square. This measuring rafter angle square having a right dash triangular member, a distance measuring device, a counter device, and a digital display. The right triangular member having a base edge, this base edge having at least one perpendicular flange along its length. In the preferred embodiment, the base edge having two perpendicular flanges thereby creating a generally T-shaped cross section for the right triangular member. The right triangular member further has a measurement edge and a hypotenuse edge. It is preferred that the intersection of the perpendicular flange and the right triangular members define a first inside corner and a second inside corner.

The distance measuring device is preferably located on either the perpendicular flange or the right triangular member. In the most preferred embodiment, the distance measuring device is incorporated within the perpendicular flange itself. This distance measuring device located adjacent to the inside corner so that when an outside corner of a piece of dimensional lumber is inserted into the inside corner, that the distance measuring device can measure a distance that the rafter angle square is slid along the piece of dimensional lumber. The distance measuring device thereby configured for measuring the distance, the rafter angle square is slid along the outside corner of the piece of dimensional lumber inserted into said inside corner.

The counter device is in communication with the distance measuring device. That being said, the distance measured by the distance measuring device is counted by the counter device. The counter device is programmed thus, to count sequentially for a pre-determined distance measured by the distance measuring device.

The digital display is located on the right triangular member. This digital display in communication with the counter device visually displaying an output of the counter device and thus, the distance measured by the distance measuring device.

Optionally, rather than a digital display or in conjunction with a digital display, the device could be provided with another counter output, including but not limited to light and/or sound.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other uses and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 shows a plan view of one embodiment of the present invention.

FIG. 2 shows an environmental end view of the second embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

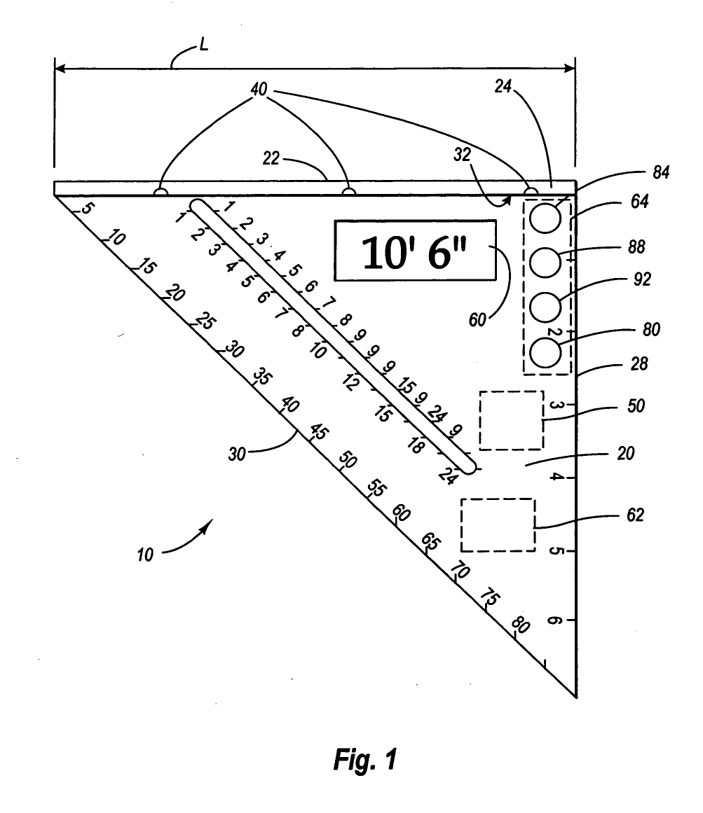

The present invention is an improved rafter angle square that includes a measuring device. Referring initially to FIG. 1, shown is one embodiment of the present invention. In that figure, shown is a rafter angle square 10. Such a rafter angle square traditionally comprising a right triangular member 20, having base edge 22, a measurement edge 28 and a hypotenuse edge 30. The measurement edge 28 traditionally is also the square edge for drawing straight lines, as is well known in the prior art.

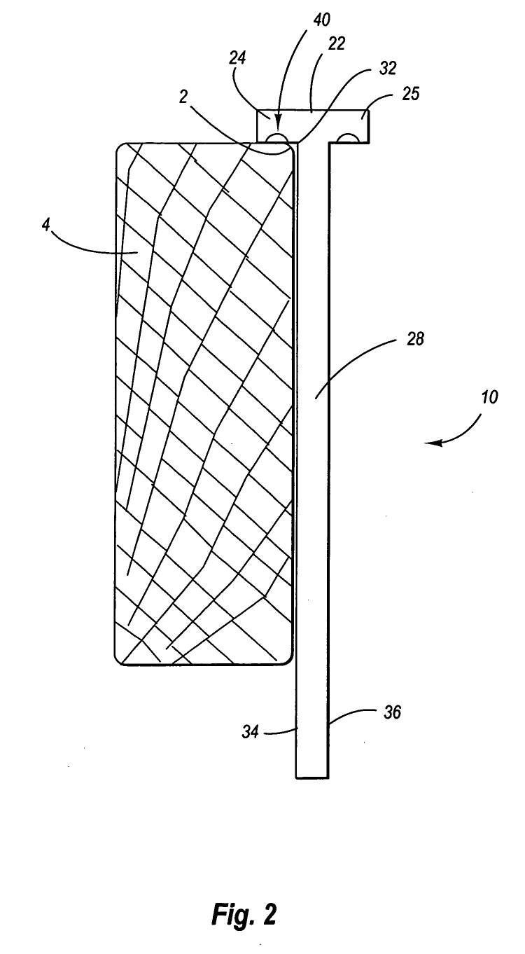

A related embodiment is shown in FIG. 2. That figure showing an end and/or cross sectional view of an embodiment of the present invention. In this embodiment, the base edge 22 has a first perpendicular flange 24 extending there from as well as a second perpendicular flange 25. These flanges working in conjunction with the body (right triangular member) 20 to create a generally T-shaped rafter angle square. While this is the preferred configuration obviously, the present invention could be provided with just one perpendicular flange thereby creating an inverted L-shaped rafter angle square.

The intersection between the perpendicular flange(s) and the body of the right triangular member thereby creating at least one inside corner 32. This inside corner 32 configured for receiving therein the outside corner 2 of a piece of dimensional lumber 4 (as shown in FIG. 2). In such an arrangement, the rafter angle square 10 is configured for sliding along the dimensional lumber 4 with the outside corner 2 generally inserted into the inside corner 32.

At least one distance measuring device 40 is located on either the perpendicular flange or the right triangular member generally adjacent to the inside corner 32. In the embodiment shown in FIGS. 1 and 2, this location is the perpendicular flange 24. In the embodiment shown in FIG. 1, a plurality of distance measuring devices are spaced along the length L of the base edge 22.

The distance measuring device(s) 40 could be any suitable manner of measuring distance, including but not limited to wheels, balls, optical devices, lasers, sonar, etc. Whatever the structure, the distance measuring device is configured for determining the distance rafter angle square 10 has moved (slid) along a surface of a piece of dimensional lumber or other material. In the preferred embodiment, the distance measuring device comprises a sensor configured for measuring the distance traveled by the rafter angle square along the surface to be measured. Preferably, this sensor comprises a light source which is shined upon the surface to be measured. An additional sensor within the distance measuring device then observes the reflection of the light off the surface to be measured and determines the distance that has been traveled. Such styles of a distance measuring devices are common within the prior art and such disclosure is intended to include such configurations, structures and types. An example of one such type of an optical measuring device is an optical computer mouse which uses such technology to determine the movement of the mouse in relation to the mouse pad or other surface.

In another embodiment of the present invention, the distance measuring device comprises a wheel mounted on an axle (or otherwise mounted) which is able to roll along the surface to be measured. A rolling ball-type distance measuring device could likewise be utilized.

The rafter angle square further including at least one counter device 50 which works in cooperation with a distance measuring device 40. This counter device 50 connected to the distance measuring device(s) 40 and programmed to count sequentially for a pre-determined distance measured by the distance measuring device(s) 40. Multiple counter devices could be provided if necessary. It is preferred that the counter device 50 be provided with a digital display 60 located upon the right triangular member and conveniently visually viewable by a user. The digital display 60 for providing a display of the output from the counter device which is interconnected to the distance measuring device. Thereby, the digital display would display visually the output of the counter device(s) and thus the distance measured by the distance measuring device(s). Examples of digital displays include but are not limited to LCD screens, mechanical counter dials, digital readouts, etc.

While it is preferred that a digital display 60 be incorporated within the device 10, it is also likewise possible that various other types of counter outputs 62 could be used in conjunction with the digital display or instead of a digital display. For instance, a speaker or other audible communication device could be provided for emitting an audible sound so that rather than (or in conjunction therewith) a digital display, a sound is created at appropriate intervals and/or measurements. In one example, as the rafter angle square is slid along the surface that is to be measured and marked, a “beep” sound could produced every sixteen (16) inches (19.2 inches, twenty-four inches, etc). Likewise, a flash of light or other type of visual display could take place indicating to the user that a pre-determined distance had been traversed. Again, while it is preferred that a “digital” display be provided, an analog or other mechanical display could likewise be used.

In conjunction with the counter device 50, a counter control apparatus 64 for controlling the output from an operation of the counter device 50. For instance, a reset 84 could be provided, in this case a reset button for resetting the counter device back to zero or another predetermined position. For instance, when starting a new measurement, a user needs to zero the device for purposes of having the appropriate measurement.

Another possible component of the counter control apparatus 64 would be a centering device/setting 88. The centering device for helping a user determine the center of a measurement (for instance the center of a door or window location). For instance, the user could zero the square, slide the square a distance, press a “centering button,” the counter control apparatus 64 would then determine the center measurement, the user would then be able to slide the square back towards the “zero” location until the display or other counter output indicates that the “center” has been reached. At such a point the user would be able to make a mark on the surface measured thereby indicating the center of the measurement.

Another possible component of the counter control apparatus would be a layout device/button 80. Various layouts could be custom entered or pre-programmed. For instance, a sixteen inch on center layout could be selected whereby the device could be zeroed and set to “beep” at every sixteen inches measured.

Yet another possible component of the counter control apparatus would be a memory device/button 92. Such a component for allowing a user to “pause” measuring when laying out a layout. For instance, when a user is laying out floor joists and/or floor trusses and the user wants to continue making a lateral layout taking into consideration bump-outs, jogs, rooms and other deviations off a straight line in a layout, the user could, when he reached the end of line, press a memory button thereby “pausing” measurement. The user would then move to the next parallel location on the layout for continuing laying out the floor joist/truss locations (after pressing the “memory” button (or other manner of reinitiating the measuring process)).

There are a number of embodiments of the present invention, some of which are discussed infra.

### EXAMPLE A

In this example, the rafter angle square comprises a right-triangular member, a distance measuring device, a counter device, and a counter output. The right triangular member having a base edge having at least one perpendicular flange along its length. The right triangular member having a measurement edge and a hypotenuse edge. The perpendicular flange and the right-triangular member defining an inside corner.

The distance measuring device is preferably located on the perpendicular flange and/or the right-triangular member. The distance measuring device is preferably located adjacent to the inside corner. The distance measuring device configured for measuring the distance the rafter angle square is slid along an outside corner of a piece of dimensional lumber inserted into the inside corner.

The counter device in communication with the distance measuring device. The said counter device preprogrammed to count sequentially for a predetermined distance measured by the distance measuring device. The counter output, preferably a digital display, located on the right-triangular member. The counter output in communication with the counter device for visually displaying an output of the counter device and thus the distance measured by the distance measuring device.

Preferably, the right-triangular member has a first side 34 opposite a second side 36 and the counter output is a digital display located on the first side and the inside corner is adjacent the second side. Optionally, the counter output of the rafter angle square could comprise a digital display on each side of the right-triangular member. Optionally, the right-triangular member has a first side opposite a second side, and the base edge has two perpendicular flanges along its length (a first flange perpendicularly extending from the first side and a second flange perpendicularly extending from the second side), this configuration resulting in a rafter angle square of generally a T-shaped cross section. Optionally, the rafter angle square comprises a counter output and at least one distance measuring device on each side of the right-triangular member. Optionally, the distance measuring device comprises a protruding roller configured for rollably traversing the surface to be measured.

Optionally, the distance measuring device comprises a sensor configured for measuring the distanced traveled by the rafter angle square along a surface to be measured. In one embodiment, this sensor comprises a light source.

Optionally, a sound emitting device in communication with the counter device for emitting a sound at a predetermined distance measured by the distance measuring device could be provided, and the predetermined distance could be changed through use of a layout device. Optionally, the counter device could further comprise a reset device for resetting the counter to a predetermined number and/or a centering device for determining the center of a distance measured by the rafter angle square and indicating that center distance to a user of the rafter angle square. Further, optionally, the counter device could comprise a memory device for allowing the rafter angle square to pause the counting by the counting device. Optionally, the rafter angle square could comprise a light emitting device (LED) or other visual display in communication with the counter device for emitting a light display at a predetermined distance measured by the distance measuring device.

### EXAMPLE B.

In this example, the rafter angle square comprises a right-triangular member, a distance measuring device, a counter device, a digital display, and a sound emitting device. The right-triangular member having a base edge, this base edge having at least one perpendicular flange along its length. The right-triangular member further having a measurement edge and a hypotenuse edge. The right-triangular member having a first side opposite a second side. The perpendicular flange and the right-triangular member defining an inside corner.

The distance measuring device located on either the perpendicular flange (preferred) or the right-triangular member. The distance measuring device adjacent to the inside corner. The distance measuring device configured for measuring the distance the rafter angle square is slid along an outside corner of a piece of dimensional lumber inserted into the inside corner. In communication with the distance measuring device is the counter device. The counter device preprogrammed to count sequentially for a predetermined distance measured by the distance measuring device. This connection preferably being electrical.

The digital display located on the right-triangular member, and in communication with the counter device for visually displaying an output of the counter device and thus the distance measured by the distance measuring device. The sound emitting device in communication with the counter device for emitting a sound at predetermined distance measured by the distance measuring device.

Optionally, the distance measuring device could comprise a protruding roller configured for rollably traversing the surface to be measured. Another option would be that the distance measuring device would comprise a sensor configured for measuring the distanced traveled by the rafter angle square along a surface to be measured.

Optionally, the counter device could further comprise a reset device for resetting the counter to a predetermined number; a centering device for determining the center of a distance measured by the rafter angle square and indicating that center distance to a user of the rafter angle square; and/or a memory device for allowing the rafter angle square to pause the counting by the counting device.

Example C. The present invention could further comprise a method of use for a rafter angle square whereby wall layouts can be quickly created. In such a method, the roofing rafter angle square comprising: a right-triangular member, a distance measuring device, a counter device and a digital display. The right triangular member having a base edge having at least one perpendicular flange along its length. The right triangular member having a measurement edge and a hypotenuse edge. The perpendicular flange and the right-triangular member defining an inside corner.

The distance measuring device located on either the perpendicular flange or the right-triangular member. The distance measuring device adjacent to the inside corner. The distance measuring device configured for measuring the distance the rafter angle square is slid along an outside corner of a piece of dimensional lumber inserted into the inside corner.

The counter device in communication with the distance measuring device. The counter device preprogrammed to count sequentially for a predetermined distance measured by the distance measuring device.

The digital display located on the right-triangular member. The digital display in communication with the counter device for visually displaying an output of the counter device and thus the distance measured by the distance measuring device.

The method of use for the rafter angle square whereby wall layouts can be quickly created may be made comprising the following steps: (a) providing a piece of dimensional lumber to be marked, the piece of dimensional lumber having an outside corner, an end and a length; (b) positioning the outside corner within the inside corner; (c) aligning the measurement edge of the rafter angle square with the piece of dimensional lumber end; (d) sliding the rafter angle square along the length; (e) stopping the sliding process when the counter reaches a predetermined measurement; and (f) making a mark upon the piece of dimensional level adjacent the measurement edge representing the predetermined measurement.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. A rafter angle square comprising:
a right-triangular member, said right triangular member having a base edge, said base edge having at least one perpendicular flange along its length, a measurement edge and a hypotenuse edge, said perpendicular flange and said right-triangular member defining an inside corner;
a distance measuring device located on either said perpendicular flange or said right-triangular member, said distance measuring device adjacent said inside corner, said distance measuring device configured for measuring the distance said rafter angle square is slid along an outside corner of a piece of dimensional lumber inserted into said inside corner;
a counter device in communication with said distance measuring device, said counter device preprogrammed to count sequentially for a predetermined distance measured by said distance measuring device; and
a counter output on said right-triangular member, said digital display in communication with said counter device for outputting to a user an output of said counter device and thus the distance measured by said distance measuring device.

2. The rafter angle square of claim 1, wherein said right-triangular member has a first side opposite a second side.

3. The rafter angle square of claim 2, wherein said counter output is a digital display located on said first side and said inside corner is adjacent said second side.

4. The rafter angle square of claim 2, wherein said counter output of said rafter angle square comprises a digital display on each side of said right-triangular member.

5. The rafter angle square of claim 1, wherein said right-triangular member has a first side opposite a second side, and said base edge has two perpendicular flanges along its length, a first flange perpendicularly extending from said first side and a second flange perpendicularly extending from said second side, said configuration resulting a rafter angle square of T-shaped cross section.

6. The rafter angle square of claim 5, wherein said rafter angle square comprises a counter output and distance measuring device on each side of said right-triangular member.

7. The rafter angle square of claim 1, wherein said distance measuring device comprises a protruding roller configured for rollably traversing the surface to be measured.

8. The rafter angle square of claim 1, wherein said distance measuring device comprises a sensor configured for measuring the distanced traveled by the rafter angle square along a surface to be measured.

9. The rafter angle square of claim 8, wherein said sensor comprises a light source.

10. The rafter angle square of claim 1, further comprising a sound emitting device in communication with said counter device for emitting a sound at predetermined distance measured by said distance measuring device.

11. The rafter angle square of claim 10, wherein said predetermined distance is changed through use of a layout device.

12. The rafter angle square of claim 1, wherein said counter device further comprises a reset device for resetting said counter to a predetermined number.

13. The rafter angle square of claim 1, wherein said counter device further comprises a centering device for determining the center of a distance measured by said rafter angle square and indicating that center distance to a user of said rafter angle square.

14. The rafter angle square of claim 1, wherein said counter device further comprises a memory device for allowing the rafter angle square to pause the counting by said counting device.

15. The rafter angle square of claim 1, further comprising a light emitting device in communication with said counter device for emitting a light display at a predetermined distance measured by said distance measuring device.

16. A rafter angle square comprising:
a right-triangular member, said right triangular member having a base edge, said base edge having at least one perpendicular flange along its length, a measurement edge and a hypotenuse edge, said right-triangular member having a first side opposite a second side, said perpendicular flange and said right-triangular member defining an inside corner;
a distance measuring device located on either said perpendicular flange or said right-triangular member, said distance measuring device adjacent said inside corner, said distance measuring device configured for measuring the distance said rafter angle square is slid along an outside corner of a piece of dimensional lumber inserted into said inside corner;
a counter device in communication with said distance measuring device, said counter device preprogrammed to count sequentially for a predetermined distance measured by said distance measuring device;
a digital display on said right-triangular member, said digital display in communication with said counter device for visually displaying an output of said counter device and thus the distance measured by said distance measuring device; and
a sound emitting device in communication with said counter device for emitting a sound at predetermined distance measured by said distance measuring device.

17. The rafter angle square of claim 16, wherein said distance measuring device comprises a protruding roller configured for rollably traversing the surface to be measured.

18. The rafter angle square of claim 16, wherein said distance measuring device comprises a sensor configured for measuring the distanced traveled by the rafter angle square along a surface to be measured.

19. The rafter angle square of claim 16, wherein said counter device further comprises:
a reset device for resetting said counter to a predetermined number;
a centering device for determining the center of a distance measured by said rafter angle square and indicating that center distance to a user of said rafter angle square; and
a memory device for allowing the rafter angle square to pause the counting by said counting device.

20. A method of use for a rafter angle square whereby wall layouts can be quickly created, said rafter angle square comprising:
a right-triangular member, said right triangular member having a base edge, said base edge having at least one perpendicular flange along its length, a measurement edge and a hypotenuse edge, said perpendicular flange and said right-triangular member defining an inside corner;
a distance measuring device located on either said perpendicular flange or said right-triangular member, said distance measuring device adjacent said inside corner, said distance measuring device configured for measuring the distance said speed square is slid along an outside corner of a piece of dimensional lumber inserted into said inside corner;
a counter device in communication with said distance measuring device, said counter device preprogrammed to count sequentially for a predetermined distance measured by said distance measuring device; and
a digital display on said right-triangular member, said digital display in communication with said counter device for visually displaying an output of said counter device and thus the distance measured by said distance measuring device;
the method of use for said rafter angle square whereby wall layouts can be quickly created may be made comprising the following steps:
(a) providing a piece of dimensional lumber to be marked, said piece of dimensional lumber having an outside corner, an end and a length;
(b) positioning said outside corner within said inside corner;
(c) aligning the measurement edge of said rafter angle square with said piece of dimensional lumber end;
(d) sliding said rafter angle square along said length;
(e) stopping said sliding process when said counter reaches a predetermined measurement; and
(f) making a mark upon said piece of dimensional level adjacent said measurement edge representing said predetermined measurement.
